(19) United States
(12) Patent Application Publication
(10) Pub. No.: US 2009/0146833 A1
(43) Pub. Date: Jun. 11, 2009

(54) Coordinator, gateway, and transmission method for IPv6 in wireless sensor network

(75) Inventors: Eun Ju Lee, Daejeon-city (KR); Jae Hong Ryu, Daejeon-city (KR); Bong Soo Kim, Youngin-si (KR); Cheol Sig Pyo, Daejeon-city (KR); Jong suk Chae, Daejeon-city (KR); Hyung Seok Kim, Seoul (KR); Youn-Soo Kim, Gyeonggi-do (KR); Sungjin Park, Gyeonggi-do (KR); Sooyoung Yang, Seoul (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/153,602

(22) Filed: May 21, 2008

(30) Foreign Application Priority Data
Dec. 11, 2007 (KR) 10-2007-0128224

(51) Int. Cl. H02J 13/00

(52) U.S. Cl. 340/825.52

(57) ABSTRACT

Provided are a coordinator, a gateway, and a transmission method for applying IPv6 in a wireless sensor network (WSN). Dual addressing of a link local address using a short address used in the WSN and a global unicast address using an extended unique identifier (EUI) of a node makes it possible to support mobility of the WSN and communicate data with an external network.

### CROSS-REFERENCE TO RELATED PATENT APPLICATION

This application claims the priority of Korean Patent Application No. 10-2007-0128224, filed on Dec. 11, 2007, in the Korean Intellectual Property Office, the disclosure of which is incorporated herein in its entirety by reference.

### BACKGROUND OF THE INVENTION

1. Field of the Invention

The present invention relates to a wireless sensor network (WSN), and more particularly, to a coordinator, a gateway, and a transmission method for applying IPv6 to nodes pertaining to a WSN.

The present invention is derived from a study conducted by the Ministry of Information and Communication (MIC) of the Republic of Korea and the Institute for Information Technology Advancement (IITA) as one of a number of new growth engine core IT technology development projects (Assignment Number: 2005-S-038-03; Assignment Name: UHF RF-ID and Ubiquitous Networking Technology Development).

2. Description of the Related Art

A wireless sensor network (WSN), which is a core technology based on a ubiquitous network, is used in a variety of application fields such as environment monitoring, medical systems, telematics, home networks, logistics systems, and the like. IEEE 802.15.4, which has low complexity, low price, low power consumption, a low data transmission speed, etc., is a standard technology applied to the WSN to realize the WSN in a variety of fields. ZigBee, which defines the specification of an upper layer including a network layer based on the conventional IEEE 802.15.4 MAC/PHY specification, is designed to maintain low power consumption and a low speed of IEEE 802.15.4.

In ZigBee, since a network layer of the WSN is not based on an IP and Internet is not interactive, ZigBee has an overhead of collecting data via specific collection equipment and processing the data in an application layer in order to provide data over Internet. Since a sensor has no global ID, it is difficult to move the sensor or individually access the sensor. It is easy to interact with a given IP network and have a global ID in order to monitor a specific sensor within the WSN all over the world. In view of the fact that most IEEE 802 network specifications are connected to an IP, since an IP core network is based on a ubiquitous network, it is advantageous that the WSN is based on the IP.

FIG. 1 illustrates a conventional i-WSN structure. Referring to FIG. 1, an i-WSN comprises sensor nodes 110, a gateway 150, and Internet including a wireless network and a router 160 based on a user station 170 and IPv6 is used to connect the sensor nodes 110, the gateway 150, and the user station 170. The user station 170 transmits a query packet requesting a sensor measurement value to the sensor node 110 through the gateway 150 via the router 160. The sensor node 110 sends the sensor measurement value to the user station 170 through the gateway 150.

An IPv6 address of a node is needed to realize the i-WSN described above. An address of a node may use a 16 bit short address allocated by a parent node in a WSN. This address may not be globally unique but dynamically change. Thus, it is difficult to support in/out mobility of a sub-network when the 16 bit short address is used as a global IPv6 address. Since a redundant address may be generated, duplicate address detection (DAD) is necessarily performed, which causes overhead.

A 64 bit extended unique identifier (EUI) is used to generate the address of the node. This address may be globally unique and can support in/out mobility in a wireless personal area network (WPAN). However, since a 64 bit address is used after a header is compressed in communication between simple internal nodes or communication via a gateway, overhead of the 64 bit EUI address is greater than that of the 16 bit short address.

Mesh routing using a 6LoWPAN mesh time/header is performed in an adaptation layer (an intermediate layer between an IP and a MAC layer, i.e., a convergence layer), and uses a MAC address. Thus, since the MAC address differs from an IP address used in an IP upper application, an intermediate transform is needed. When an IP header is not compressed, redundant information is included in the IP header. When the 64 bit EUI is used, overhead of originator and destination addresses is increased.

Although routing algorithms such as HILOW, LOAD, etc. have been suggested for use in a 6LoWPAN, efforts are been made to enhance the performance of the above routing algorithms. However, the above routing algorithms do not reduce route overhead on an address system or a header of an IP header or a mesh header. Furthermore, it is necessary to maintain a data packet transmission route in a mobile node other than the WPAN.

FIG. 2 illustrates a conventional WSN. Referring to FIG. 2, circles refer to nodes and numbers in the circles refer to addresses of nodes. When an address of each node is hierarchically allocated via a coordinator, if a link loss occurs between a node 210 that is a child node of a 1^{st} node 220 and the 1^{st} node 220, an address of the 6^{th} node 210 is changed to an address of an 11^{th} node that is a child node of a 2^{nd} node 230. In this regard, if a 10^{th} node 240 has sent data to the previous address of the 6^{th} node after the address of the 6^{th} node 210 is changed to the address of the 11^{th} node, the transmission of the data is failed due to a change in an address of the node.

FIG. 3 illustrates another conventional WSN. Referring to FIG. 3, a left WSN is a subnet A and a right WSN is a subnet B. A typical node movement between WPANs is that a 10^{th} node 310 of the subnet A physically moves to the subnet B and is changed to a 7^{th} node 330 that is a child node of a 1^{st} node 340 of the subnet B. If a 1St node 320 of the subnet A has been sending data to the 10^{th} node 310 of the subnet A, the 1 st node 320 of the subnet A can keep sending the data to the 7^{th} node 330 in spite of a movement of nodes.

### SUMMARY OF THE INVENTION

The present invention provides a method and apparatus for providing an IPv6 address system capable of supporting internal or external mobility in a wireless personal area network (WPAN), thereby reducing overhead in a wireless sensor network (WSN).

According to an aspect of the present invention, there is provided a gateway for IPv6 in a wireless sensor network (WSN), the gateway comprising: a table generator generating a table by using received extended unique identifiers (EUls) and short addresses; a searching unit extracting a short address of an originator node of a packet received from inside the WSN from a source address of the packet and searching for an EUI corresponding to the extracted short address from the table; and a source address changing unit generating a global unicast address by using a found EUI and changing the source address to the global unicast address.

According to another aspect of the present invention, there is provided a gateway for IPv6 in a WSN, the gateway comprising: a table generator generating a table by using received EUls and short addresses; a searching unit extracting an EUI of a destination node of a received packet from a destination address of the packet if the destination address of the packet is inside the WSN and searching for a short address corresponding to the extracted EUI from the table; and a destination address changing unit generating a link local address by using a found short address and changing the destination address to the link local address.

According to another aspect of the present invention, there is provided a method of transmitting IPv6 in a coordinator of a WSN, the method comprising: generating a link local address by using a short address allocated to a child node; transmitting the short address and an EUI received from the child node to a gateway; and transmitting the link local address to the child node.

According to another aspect of the present invention, there is provided a method of transmitting IPv6 in a gateway of a WSN, the method comprising: generating a table by using received EUIs and short addresses; extracting a short address of an originator node of a packet received from inside the WSN from a source address of the packet and searching for an EUI corresponding to the extracted short address from the table; and generating a global unicast address by using a found EUI and changing the source address to the global unicast address.

According to another aspect of the present invention, there is provided a method of transmitting IPv6 in a gateway of a WSN, the method comprising: generating a table by using received EUIs and short addresses; extracting an EUI of a destination node of a received packet from a destination address of the packet if the destination address of the packet is inside the WSN and searching for a short address corresponding to the extracted EUI from the table; and generating a link local address by using a found short address and changing the destination address to the link local address.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional i-wireless sensor network (WSN) structure;

FIG. 2 illustrates a conventional WSN;

FIG. 3 illustrates another conventional WSN;

FIG. 4 illustrates a process of accessing nodes and allocating short addresses according to an embodiment of the present invention;

FIG. 5 illustrates a process of generating a link local address and a global unicast address according to an embodiment of the present invention;

FIG. 6 is a diagram of a structure of a global unicast address according to an embodiment of the present invention;

FIG. 7 is a diagram of a structure of a link local address according to an embodiment of the present invention;

FIG. 8 is a table illustrating 16 bit short addresses and pairs of 64 bit extended unique identifier (EUI) addresses that are used in a gateway according to an embodiment of the present invention;

FIG. 9 is a diagram for explaining a process of communicating data between IPv6 based Internet and a WSN according to an embodiment of the present invention;

FIG. 10 is a diagram for explaining a process of communicating data between IPv6 based Internet and a WSN according to another embodiment of the present invention;

FIG. 11 is a diagram of a structure of an IP header according to an embodiment of the present invention;

FIG. 12 is a data flow chart illustrating an address change process during data communication in the same network when a node is in a static state according to an embodiment of the present invention;

FIG. 13 is a data flow chart illustrating an address change process during data communication in the same network when a node is in a dynamic state according to an embodiment of the present invention;

FIG. 14 illustrates an occurrence of a router error during data communication in the same network when a node is in a dynamic state according to an embodiment of the present invention;

FIG. 15 is a data flow chart illustrating an address change process during data communication with an external network according to an embodiment of the present invention; and

FIG. 16 is a data flow chart illustrating an address change process during data communication with an external network in a mesh network according to an embodiment of the present invention.

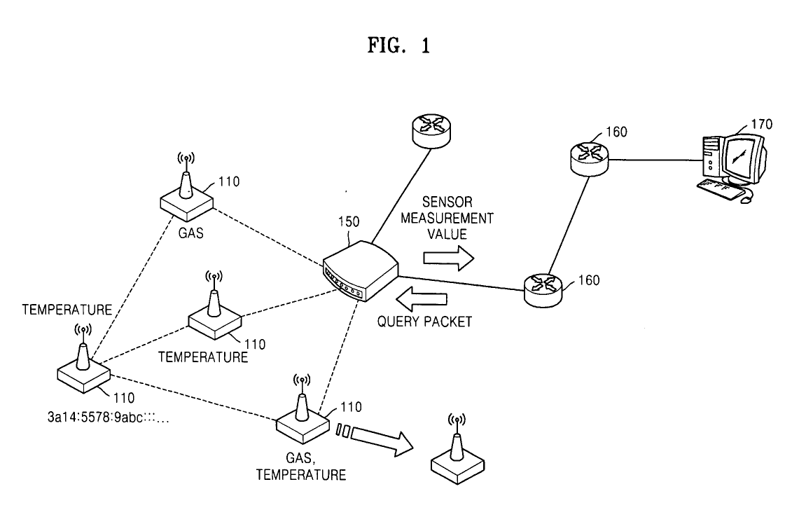

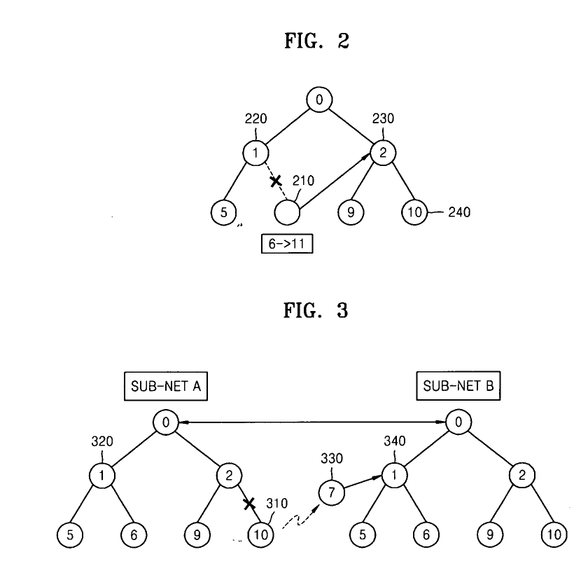

### DETAILED DESCRIPTION OF THE INVENTION

Hereinafter, the present invention will be described in detail by explaining embodiments of the invention with reference to the attached drawings.

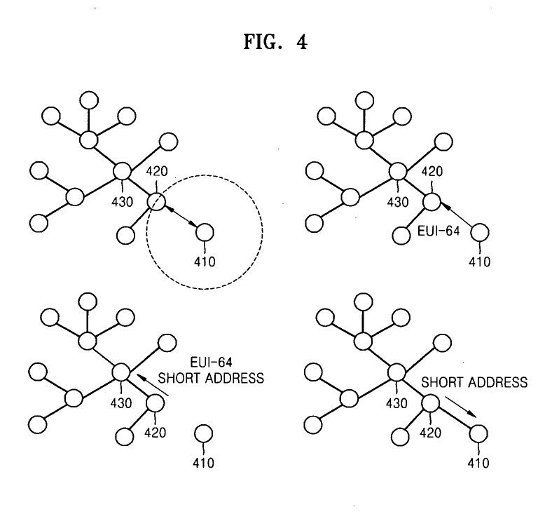

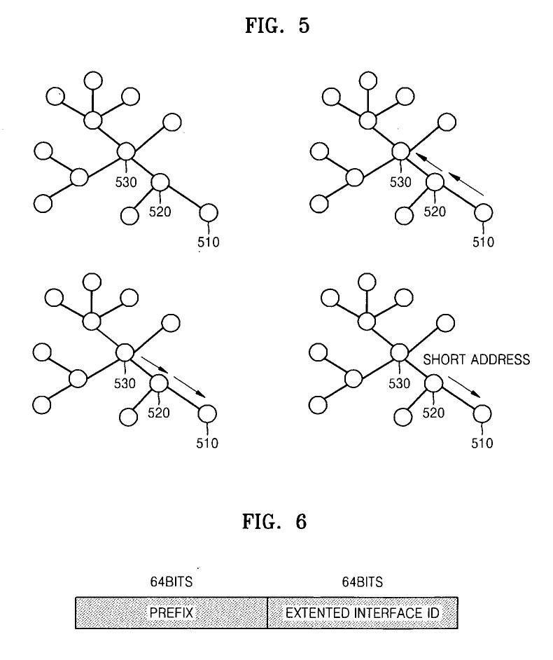

FIG. 4 illustrates a process of accessing nodes and allocating short addresses according to an embodiment of the present invention. Referring to FIG. 4, a node 410 and a parent node 420 of the node 410 attempt to associate with a network having a node 430 as a gateway. A passive scan may be excluded and an active scan may be performed in order to reduce power consumption when scanning is performed. This will be described with reference to FIG. 5. If the node 410 transmits a 64 bit extended unique identifier (EUI) to the parent node 420 that is a coordinator in order to request association with the network, the parent node 420 reports the 64 bit EUI and a pair of short addresses of a sensor node that attempts to newly associate with the gateway 430, and the gateway 430 newly adds the 64 bit EUI and the pair of short addresses to an internal table. By performing such a process, an address transform table of all nodes of a subnet pertaining to a gateway can be obtained.

FIG. 5 illustrates a process of generating a link local address and a global unicast address according to an embodiment of the present invention. Referring to FIG. 5, nodes 510, 520 and 530 respectively correspond to nodes 410, 420 and 430 in FIG. 4. If the node 510 associates with a subnet having the node 530 as a gateway, the parent node 520 generates the link local address using a short address allocated to the node 510. Then, the node 510 broadcasts the link local address generated through a router solicitation. The gateway 530 sends a prefix of a network to the node 510 through a router advertisement in response to the router request. Regular broadcasting of the router advertisement by the gateway (passive scan) results in a great amount of power consumption and thus a request/response broadcasting (active scan) is appropriate for normal operation of a WSN. The node 510 generates the global unicast address by using the prefix and its own 64 bit EUI.

Next, a method of communicating data between IPv6 based Internet and a sensor network will be described.

A given ZigBee network mainly uses the 16 bit short address that is unique in a single wireless personal area network (WPAN). However, if an IP is applied to a sensor network and mobility is required, the 16 bit short address that is provided in a serving WPAN has to be used in a target WPAN. Although a new address can be provided, the new address cannot be used as a globally unique identifier. Thus, although a sensor node has the globally unique identifier and continuously moves to another WPAN, it is necessary to maintain the globally unique identifier or the new address to continuously connect a given communication in an IP based WSN.

As described above, the 6PoWPAN designates two methods of generating an IPv6 address by generating an interface ID using the 16 bit short address and the 64 bit EUI. However, the two methods have advantages and disadvantages.

When the IPv6 address is generated using the 16 bit short address, overhead of a header is small when the header is compressed. However, the IPv6 address is not globally unique but can dynamically change, making it impossible to support internal/external mobility of the subnet.

When the IPv6 is generated using the 64 bit EUI, the IPv6 address is globally unique and can support internal/external mobility of the WPAN. However, although the header is compressed, a 64 bit address is necessary for simple communication of nodes inside the subnet or a communication by a gateway, causing a lot of overhead.

Therefore, a means of improving the method of generating an IPv6 address, by combining, two method of generating an IPv6 address by generating an interface ID using the 16 bit short address and the 64 bit EUI is suggested in the present invention. In addition to the 16 bit short address that is mainly used in a fixed WPAN having a small amount of overhead, the 64 bit EUI provided by the IEEE 802.15.4 is used as a basic address factor. The 64 bit EUI is based on the generation of the IPv6 address.

FIG. 6 is a diagram of a structure of a global unicast address according to an embodiment of the present invention. Referring to FIG. 6, the global unicast address comprises 128 bits in which upper 64 bits are a prefix and lower 64 bits are a 64 bit EUI. As described above, the prefix is reported to a node that is transmitted by a router and newly associates with a network in a router advertisement section. The global unicast address is referred to as a global address in the present specification. The global address is unique in all WPANs, whereas it does not provide a hierarchical address that can be used in a hierarchical tree routing that can be performed using low power/low memory resources in a wireless communication mesh network. Thus, in the present invention, a link local address is additionally assigned to be used for hierarchical tree routing.

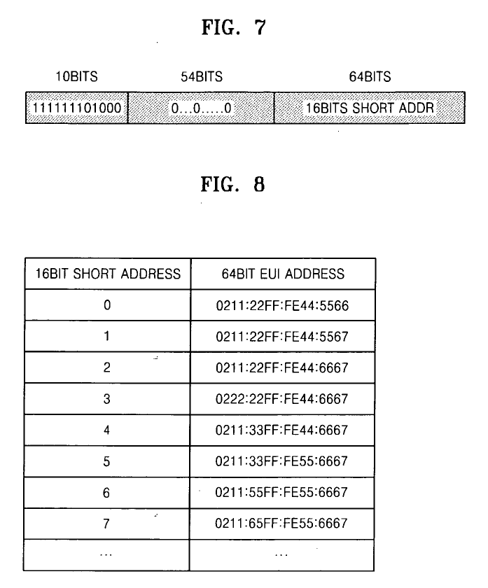

FIG. 7 is a diagram of a structure of a link local address according to an embodiment of the present invention. Referring to FIG. 7, the link local address uses a 16 bit short address and is based on a prefix generating the link local address. The link local address is generated and managed in a coordinator that is a parent node of each node like the given 16 bit short address. The link local address may change when a sensor node moves in a WPAN. Although the 16 bit short address is unique in the WPAN, it may be changed to another address since the sensor node moves and a link between the sensor node and another node changes. In this case, the link local address may change. The link local address may be used in a local WPAN. When a packet is sent to the outside through a gateway, the link local address is exchanged with a matching global address in the gateway.

FIG. 8 is a table illustrating 16 bit short addresses and pairs of 64 bit EUI addresses that are used in a gateway according to an embodiment of the present invention. Referring to FIG. 8, 16 bit short addresses in a left column are used to generate a link local address and 64 bit EUI addresses in a right column are used as unique media access control (MAC) addresses, resulting in a format like an address resolution protocol (ARP). When a node sends data to a specific global address, if the data arrives at a gateway, the gateway searches for a table and changes a destination address to the link local address if a destination is within the same network, and the data is transmitted to a MAC address as a short address. If the destination is not the same WPAN, the gateway transmits the data to the outside to the global address. If an originator has transmitted the data based on the link local address to a node in the same WPAN, it is possible to arrive at a destination within the WPAN by using a hierarchical routing algorithm without having to pass through the gateway.

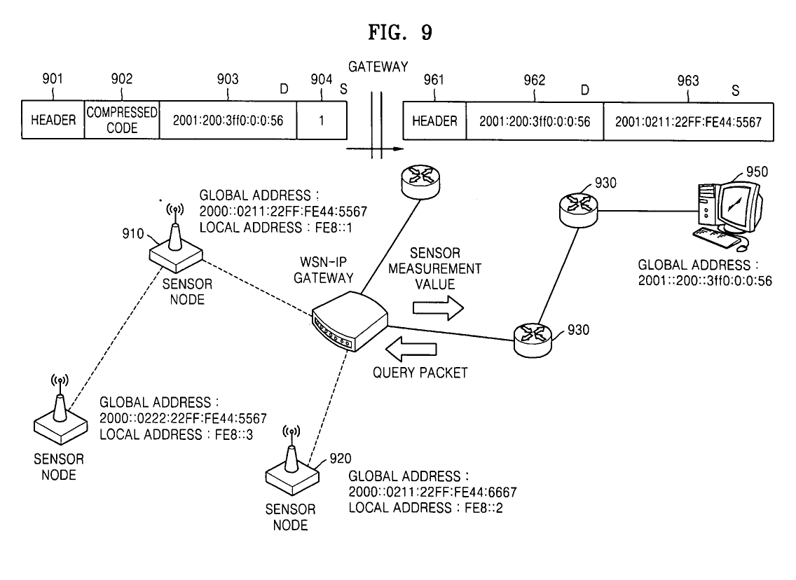

FIG. 9 is a diagram for explaining a process of communicating data between IPv6 based Internet and a WSN according to an embodiment of the present invention. Referring to FIG. 9, a sensor node 910 has 1 as a 16 bit short address, i.e., FE8::1 as a link local address, and 0x0211_{—}22FF_FE44_{—}5567 as a 64 bit EUI. The sensor node 910 generates 2000::0211:22 FF:FE44:5567 as a global address. When the sensor node 910 sends a data packet to a user station 950 having an address 2001:200::3FFO:0:0:56 in an external wired network, a packet that is initially generated in a source has a code 902 for compressing a MAC header and an IPv6 header and is in a format of a compressed IPv6 header. Although the packet that is sent to the outside has a global address in a destination field 903 and has a link local address in a source field 904, since the packet is compressed, the packet has only 1 in the source field 904. If the compressed IPv6 packet is transferred to a gateway, the gateway releases the compressed packet. The IPv6 header is completed based on a compression code next to an Ethernet MAC header. A source address 963 changes 1 as the 16 bit short address to the global address 2000::0211:22 FF:FE44:5567 based on an internal table.

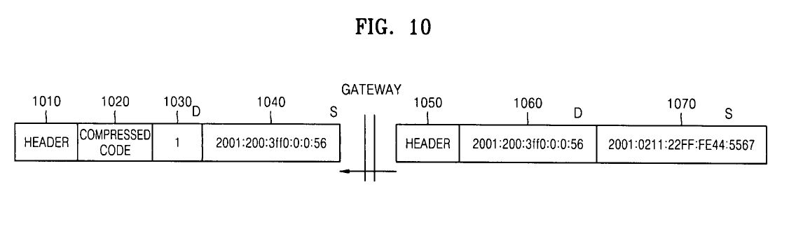

FIG. 10 is a diagram for explaining a process of communicating data between IPv6 based Internet and a WSN according to another embodiment of the present invention. Referring to FIG. 10, when a packet is sent to the WSN from outside, the packet is processed in an opposite manner as described in FIG. 9. A gateway removes an Ethernet header of the packet, changes a destination address 1060 that is a global address to a link local address, compresses the link local address, and inserts the compressed link local address into a destination field in the format of a short address (1020 and 1030).

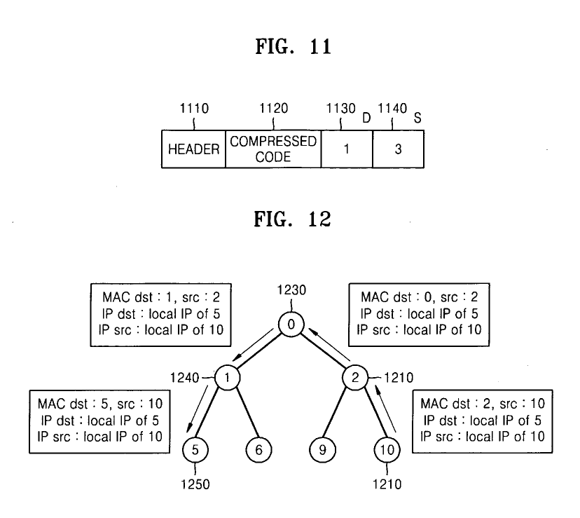

FIG. 11 is a diagram of a structure of an IP header according to an embodiment of the present invention. Referring to FIG. 11, a sensor node transmits a packet to a node in a WPAN having the same prefix by using a 16 bit short address as each address of a destination address field 1130 and a source address field 1140. The packet can be transmitted through routing having limited overhead in the same WPAN.

FIG. 12 is a data flow chart illustrating an address change process during data communication in the same network when a node is in a static state according to an embodiment of the present invention. Referring to FIG. 12, addresses are sequentially allocated from a personal area network (PAN) coordinator (gateway) to children in a WSN having a hierarchical structure. When the node is in the static state, tree routing is performed using a general hierarchical routing method. In the WSN where the node is in the static state, since a link local address of each node does not change, an originator of data can express destination and source addresses of an IP header in the format of the link local address. A 10^{th} node 1210 has a destination address of 5 in the form of a compressed link local address and a source address of 10 in the form of the compressed link local address to transmit the data. 2^{nd}, 0^{th}, and 1^{st} nodes that sequentially receive the data from the 10^{th} node have the same destination and source nodes as described above. Although a MAC address is changed to each address of a next node and its own node to which the data is transmitted according to a routing route, an address type is the link local address.

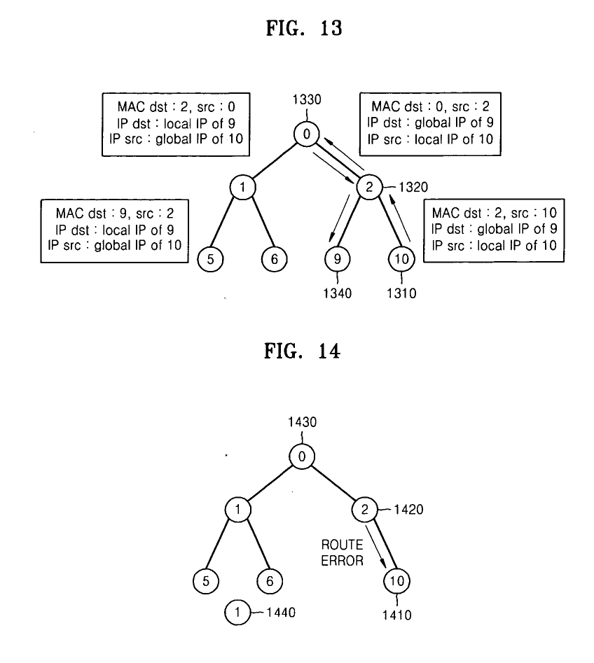

FIG. 13 is a data flow chart illustrating an address change process during data communication in the same network when a node is in a dynamic state according to an embodiment of the present invention. Referring to FIG. 13, a 10^{th} node 1310 is an originator node and a gth node 1340 is a destination node. A link local address of the 9^{th} node 1340 can be changed since the node is in the dynamic state. Thus, when the 10^{th} node 1310 transmits a packet to the 9^{th} node 1340, a destination address must be designated as a global address in a header of the packet. Since it is impossible to be informed of all IPv6 addresses in a network having a great number of sensor nodes, a domain name service such as the Internet can be used to transmit data to each necessary sensor node or actuator node. In the present invention, it is assumed that an originator node is informed of an IPv6 global address of a destination as described in a general routing protocol. The 10^{th} node 1310 inserts the global address of the 9^{th} node 1340 into a destination address (IP dst). The gateway 1330 receives a data packet and changes a destination address of a header of the data packet in the form of a global address to a link local address based on an address change table to transmit the data packet to a final destination with limited overhead. The gateway 1330 changes the link local address matching the global address using a table including updated latest information to transmit the data packet to a current location of the final destination, so that data can be transmitted in the network including mobile nodes.

FIG. 14 illustrates an occurrence of a router error during data communication in the same network when a node is in a dynamic state according to an embodiment of the present invention. Referring to FIG. 14, an unexpected movement of the node may occur when data is transmitted in the same manner as used in the network where the node is in the static state shown in FIG. 12. In more detail, when a 9^{th} node that is a final destination moves or an intermediate link fails, a 2^{nd} node that is a parent node (coordinator) of the 9^{th} node detects the movement of the final destination or the intermediate link failure (e.g., by using a beacon), and the router error occurs in a packet heading for a destination of the 9^{th} node. However, since an acknowledgement ACK is supposed to be received in a TCP, when an originator node 1410 does not receive the ACK, the router error can occur, which can be detected and solved.

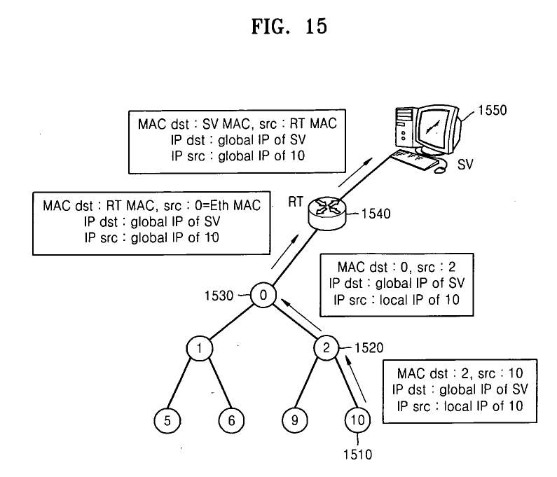

FIG. 15 is a data flow chart illustrating an address change process during data communication with an external network according to an embodiment of the present invention. Referring to FIG. 15, a data packet communicating with a sensor node in an external Internet or an external different WPAN performs routing as follows. The data packet is transmitted to a gateway via default routing in the same manner as an Internet connection of a wired local network. When a node is in a dynamic state, a gateway 1530 receives the data packet having a destination address in the form of a global address and changes a source address of the data packet to the global address based on an internal table to transmit the data packet to the external network, in the same manner as changing the address during data communication in the same network. When the node is in the dynamic state inside the network, since the address change process during the data communication is identical to that during the data communication in the same network, there is no additional overhead in order to support internal/external routing.

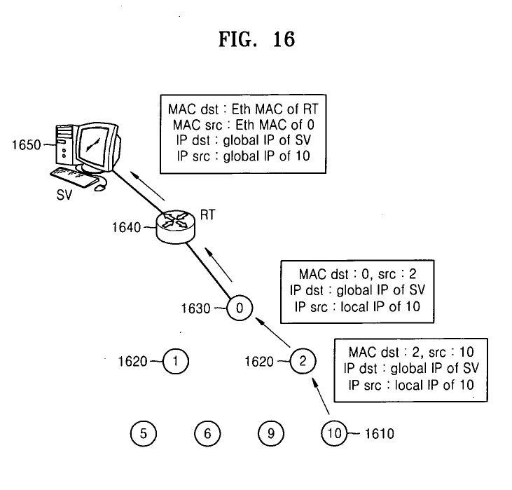

FIG. 16 is a data flow chart illustrating an address change process during data communication with an external network in a mesh network according to an embodiment of the present invention. Referring to FIG. 16, router and header address information is obtained by performing wireless network internal routing that is a type of mesh ad hoc on-demand distance vector (AODV) routing. While the mesh AODV routing is expected to increase overhead necessary for a search of a route to a gateway when nodes move compared to tree routing, it has an advantage of a minimum route distance between nodes in a wireless network. In more detail, since a wireless sensor node has limited power and memory resources that are of importance, minimum distance route routing may not be the best.

A coordinator for supporting IPv6 in a WSN is as follows. The coordinator comprises a link local address generating unit, a gateway transmitting unit, and a child node transmitting unit. The link local address generating unit generates a link local address using a short address allocated to a child node in the WSN. The gateway transmitting unit transmits a pair of the link local address (or a short address) and a 64 bit EUI received from the child node to a gateway. The pair of the link local address and the 64 bit EUI is included in a table for an address change in the gateway. The child node transmitting unit transmits the link local address generated in the link local generating unit to allow the child node to be informed of its own link local address.

The coordinator is basically the same as a method of generating an address for IPv6 in a coordinator of a WSN described above.

A gateway for supporting IPv6 in the WSN comprises a table generating unit, a searching unit, and a source address changing unit for transmitting a packet received from inside of a network to inside or outside of the network. The table generating unit generates an address change table using a pair of the 64 bit EUI and a short address received from the coordinator, as described in relation to the coordinator. Although the short address may not be received from the coordinator, it can be obtained from the link local address received from the coordinator. The searching unit searches for an EUI-64 of an originator node from a source address of a received packet. The source address may be in the form of a general link local address. However, the source address must be in the form of a global address in order to support mobility in the WSN. Thus, the originator node must be informed about the EUI-64 in order to change the source address in the form of the link local address to the global address. The source address changing unit generates the global address using the EUI-64 found by the searching unit and replaces the source address with the global address.

A gateway for supporting IPv6 in the WSN comprises a table generating unit, a searching unit, and an originator address changing unit for transmitting a packet received from outside of a network to inside of the network. The table generating unit generates an address change table by using a pair of the 64 bit EUI and a short address received from the coordinator, as described in relation to the coordinator. Although the short address may not be received from the coordinator, it can be obtained from the link local address received from the coordinator. The searching unit searches for a short address of an originator node from a source address of a received packet. The destination address may be in the form of a global address. However, the destination address must be in the form of a link local address in order to reduce overhead in the WSN. Thus, the destination node must be informed about a short address in order to change the destination address in the form of the global address to the link local address. The destination address changing unit generates the link local address using the short address found by the searching unit and replaces the destination address with the link local address.

The gateways are basically the same as the method of generating an address for IPv6 in a gateway of a WSN as described above.

The present invention can communicate data internally or externally in a WSN, thereby reducing overhead during the communication of data.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A gateway for IPv6 in a wireless sensor network (WSN), the gateway comprising:
a table generator generating a table by using received extended unique identifiers (EUls) and short addresses;
a searching unit extracting a short address of an originator node of a packet received from inside the WSN from a source address of the packet and searching for an EUI corresponding to the extracted short address from the table; and
a source address changing unit generating a global unicast address by using a found EUI and changing the source address to the global unicast address.

2. The gateway of claim 1, wherein the source address changing unit generates the global unicast address by using the EUI as an interface ID.

3. The gateway of claim 1, wherein the source address changing unit changes the source address to the global unicast address if a destination of the packet is outside of the network or the originator node is a mobile node.

4. A gateway for IPv6 in a WSN, the gateway comprising:
a table generator generating a table by using received EUls and short addresses;
a searching unit extracting an EUI of a destination node of a received packet from a destination address of the packet if the destination address of the packet is inside the WSN and searching for a short address corresponding to the extracted EUI from the table; and
a destination address changing unit generating a link local address by using a found short address and changing the destination address to the link local address.

5. The gateway of claim 4, wherein the destination address changing unit generates the link local address by using the short address as an interface ID.

6. The gateway of claim 4, wherein the destination address changing unit compresses the link local address to the found short address and changes the destination address to the compressed short address.

7. A method of transmitting IPv6 in a coordinator of a WSN, the method comprising:
generating a link local address by using a short address allocated to a child node;
transmitting the short address and an EUI received from the child node to a gateway; and
transmitting the link local address to the child node.

8. The method of claim 7, wherein the generating of the link local address source comprises: generating the link local address by using the short address as an interface ID.

9. The method of claim 7, wherein the transmitting comprises: receiving the EUI through a router request of the child node.

10. The method of claim 7, further comprising: if the destination address of the packet received from the child node is in the form of a global unicast address, transmitting the packet to the gateway, and
if the destination address of the packet received from the child node is not in the form of a global unicast address, transmitting the packet to the gateway by using a hierarchical routing method.

11. A method of transmitting IPv6 in a gateway of a WSN, the method comprising:
generating a table by using received EUIs and short addresses;
extracting a short address of an originator node of a packet received from inside the WSN from a source address of the packet and searching for an EUI corresponding to the extracted short address from the table; and
generating a global unicast address by using a found EUI and changing the source address to the global unicast address.

12. The method of claim 11, wherein the generating of the global unicast address comprises: generating the global unicast address by using the EUI as an interface ID.

13. The method of claim 11, wherein the generating of the global unicast address comprises: changing the source address to the global unicast address if a destination of the packet is outside of the network or the originator node is a mobile node.

14. A method of transmitting IPv6 in a gateway of a WSN, the method comprising:
generating a table by using received EUls and short addresses;
extracting an EUI of a destination node of a received packet from a destination address of the packet if the destination address of the packet is inside the WSN and searching for a short address corresponding to the extracted EUI from the table; and
generating a link local address by using a found short address and changing the destination address to the link local address.

15. The method of claim 14, wherein the generating of the link local address comprises: generating the link local address by using the short address as an interface ID.

16. The method of claim 14, wherein the generating of the link local address comprises: compressing the link local address to the found short address and changing the destination address to the compressed short address.
